(19) United States
(12) Patent Application Publication
(10) Pub. No.: US 2026/0140772 A1
(43) Pub. Date: May 21, 2026

(54) ENHANCING MACHINE LEARNING WORKLOADS WITH OPTIMIZED GPU UTILIZATION

(71) Applicant: eBay Inc., San Jose, CA (US)

(72) Inventors: Haowei Tian, Shanghai (CN); Zhengfei Chen, Shanghai (CN); Vinay Phegade, Santa Clara, CA (US); Xin Li, Shanghai (CN); Guansheng Zhu, Shanghai (CN); Yiheng Wang, Shanghai (CN); Zhongyuan Wu, Shanghai (CN); Yucai Yu, Shanghai (CN)

(21) Appl. No.: 18/950,825

(22) Filed: Nov. 18, 2024

(51) Int. Cl. G06F 9/50

(52) U.S. Cl. CPC G06F 9/5027

(57) ABSTRACT

A request associated with a computing task is received. A machine learning (ML) model is identified based on the request. Metadata preconfigured for the ML model is retrieved. A graphics processing unit (GPU) resource is dynamically allocated based on the metadata preconfigured for the ML model. The computing task associated with the request is processed using the allocated GPU resource.

### TECHNICAL FIELD

The present disclosure generally relates to data processing using machine learning technologies. More particularly, various embodiments described herein provide for systems, methods, techniques, instruction sequences, and devices that facilitate enhancing machine learning workloads with optimized GPU utilization.

### BACKGROUND

The field of artificial intelligence (AI) has experienced significant growth. This advancement has led to the creation of larger and more complex machine learning models. As these models have evolved, they have substantially increased the demands on computational resources, such as Graphics Processing Units (GPUs). The rapid expansion of AI applications across various platforms requires infrastructures that can adapt and scale to meet these growing computational needs. Machine learning workloads with low GPU utilization are often hindered by Central Processing Unit (CPU) and memory bottlenecks. The task of splitting CPU and GPU workloads to overlap their computations demands substantial development work, which adds complexity and extends timelines.

### BRIEF DESCRIPTION OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some embodiments are illustrated by way of examples, and not limitations, in the accompanying figures.

FIG. 1 is a block diagram showing an example data system that includes a data management system, according to various embodiments of the present disclosure.

FIG. 2 is a block diagram illustrating an example data management system that facilitates enhancing machine learning workloads with optimized GPU utilization, according to various embodiments of the present disclosure.

FIG. 3 is a flowchart illustrating an example method for enhancing machine learning workloads with optimized GPU utilization, according to various embodiments of the present disclosure.

FIG. 4 is a flowchart illustrating an example method for enhancing machine learning workloads with optimized GPU utilization, according to various embodiments of the present disclosure.

FIG. 5 is a diagram illustrating a data flow that facilitates enhancing machine learning workloads with optimized GPU utilization, according to various embodiments of the present disclosure.

FIG. 6 is a block diagram illustrating a representative software architecture, which may be used in conjunction with various hardware architectures herein described, according to various embodiments of the present disclosure.

FIG. 7 is a block diagram illustrating components of a machine able to read instructions from a machine storage medium and perform any one or more of the methodologies discussed herein according to various embodiments of the present disclosure.

### DETAILED DESCRIPTION

The description that follows includes systems, methods, techniques, instruction sequences, and computing machine program products that embody illustrative embodiments of the present disclosure. In the following description, for purposes of explanation, numerous specific details are set forth in order to provide a thorough understanding of embodiments. It will be evident, however, to one skilled in the art that the present inventive subject matter may be practiced without these specific details.

Reference in the specification to “one embodiment” or “an embodiment” means that a particular feature, structure, or characteristic described in connection with the embodiment is included in at least one embodiment of the present subject matter. Thus, the appearances of the phrase “in one embodiment” or “in an embodiment” appearing in various places throughout the specification are not necessarily all referring to the same embodiment.

For purposes of explanation, specific configurations and details are set forth in order to provide a thorough understanding of the present subject matter. However, it will be apparent to one of ordinary skill in the art that embodiments of the subject matter described may be practiced without the specific details presented herein, or in various combinations, as described herein. Furthermore, well-known features may be omitted or simplified in order not to obscure the described embodiments. Various embodiments may be given throughout this description. These are merely descriptions of specific embodiments. The scope or meaning of the claims is not limited to the embodiments given.

GPU processing is essential for handling high-complexity and large-scale data types, including image and video data. In existing systems, GPU utilization in machine learning workloads is often hindered by CPU and memory bottlenecks due to several factors. For example, data preprocessing and transfer delays can cause the GPU to wait for data, particularly when CPU-bound tasks are slow, or memory bandwidth is limited. Inefficient task scheduling and limited CPU resources also contribute, as the CPU may struggle to keep up with the demands of feeding data to the GPU, leading to GPU idle time. Memory bottlenecks, such as insufficient RAM or frequent cache misses, can further slow down the process, causing delays in data preparation and transfer. Synchronization overheads and high latency in data pipelines exacerbate the problem, as the GPU often waits for the CPU to complete necessary tasks, reducing the GPU's potential for parallel processing. Overall, these bottlenecks lead to underutilization of the GPU, which impacts the efficiency and performance of machine learning workloads.

Various embodiments include systems, methods, and non-transitory computer-readable media that facilitate enhancing machine learning workloads with optimized GPU utilization, according to various embodiments of the present disclosure. Specifically, various embodiments involve a machine learning platform that facilitates a seamless transition of various categories of ML models from development to production, enhancing resource efficiency. In particular, the machine learning platform reduces the necessity for extensive code rewrites and minimizes the need for engineering intervention, thereby decreasing both development time and communication overhead.

Various embodiments also involve using of a distributed computing framework designed to scale and simplify the development of machine learning (ML) and other high-performance applications within the machine learning platform to enhance the efficiency of machine learning workflows. Specifically, the distributed computing framework helps optimize GPU utilization by effectively balancing CPU and GPU workloads and introduces heterogeneous computing and dynamic resource management with autoscaling features. These capabilities are beneficial in addressing prevalent challenges related to GPU availability and utilization, promoting more effective and adaptable machine learning workflows. In particular, various embodiments enhance the machine learning platform's ability to maximize GPU availability and utilization, which is important for efficiently managing computational demands. The platform significantly improved GPU utilization by decoupling CPU and GPU computations using metadata preconfigured for each type of machine learning model. This separation allows for more efficient management of resources, ensuring that GPUs are not left idle while waiting for CPU-bound tasks to be completed. The improved GPU utilization rates lead to faster training times and more efficient use of hardware, ultimately contributing to a more agile development process and leveraging computational resources to their fullest potential.

In various embodiments, after machine learning models have been trained (and validated), the model can be deployed on the machine learning platform described herein. The process of deploying machine learning models for use in real-time or near-real-time applications can be referred to as model serving. A served (or deployed) machine learning model can handle live (or real-time) requests (from users and systems), process data in the live request, and return results (via model outputs) immediately through APIs or user interfaces. Serving large language models can oftentimes require significant GPU utilization, particularly when the incoming data includes, without limitation, image data, video data, 3D data, and audio data.

In various embodiments, a data management system receives one or more requests. Each request can be associated with a computing task to be handled (or processed) by a machine learning model. Example computing tasks handled by machine learning models can include, without limitation, image and text classification, object detection, regression, anomaly detection, recommendation systems, time series forecasting, clustering, reinforcement learning, ranking, generative models, and predictive maintenance.

In various embodiments, the data management system identifies a machine learning (ML) model (or a type or a category of ML models) based on the request. The data management system retrieves metadata preconfigured for the ML model (or the type or category of ML models).

In various embodiments, the data management system dynamically allocates a graphics processing unit (GPU) resource based on the metadata preconfigured for the ML model. The GPU resource comprises one or more GPU nodes. Each GPU node can correspond to a physical machine (e.g., a computer). Each computer can have one or more CPUs and one or more GPUs. A CPU handles general-purpose computing tasks and manages the system's operations, while a GPU is specialized for parallel processing and accelerates tasks like graphics rendering, machine learning, and complex computations.

In various embodiments, metadata preconfigured for an ML model can include a GPU allocation policy, a CPU allocation policy, and a memory allocation policy preconfigured based on one or more characteristics of the ML model (or the type or category of the ML model).

In various embodiments, the data management system uses the GPU resource to process the computing tasks associated with one or more requests.

In various embodiments, a request can include data to be processed by a specific ML model. Such data can include one or more images and/or one or more videos, as examples.

In various embodiments, the data management system retrieves GPU code associated with the ML model. The data management system uses the allocated GPU resource (e.g., one or more GPU nodes) to process the computing tasks associated with the one or more requests based on the GPU code.

In various embodiments, the data management system dynamically allocates a central processing unit (CPU) resource and a memory resource based on the one or more requests. The data management system uses the allocated CPU resource, memory resource, and GPU resource to process the computing tasks associated with the one or more requests.

In various embodiments, the data management system monitors a volume of a plurality of requests associated with computing tasks executable by the ML model. The volume of requests can be monitored via various metrics associated with the ML model's workload. An example metric can involve monitoring the volume of a plurality of requests based on the length of the task queue and the time tasks spend waiting for a resource (e.g., one or more GPU nodes) allocated to the ML model. Each node (e.g., GPU node, CPU node) allocated to the ML model can be associated with a queue. A longer task queue and/or a longer wait time indicate an increased demand, and vice versa. Another example metric can involve using historical workload data to predict future workload demand. This allows for adjusting resources proactively before a surge in requests occurs, avoiding resource shortages or overprovisioning.

In various embodiments, the data management system dynamically adjusts the size of the GPU resource in response to the monitoring of the volume of the plurality of requests. For example, if the volume of requests, the length of a task queue, and/or a wait time exceeds a threshold value, the data management system can increase the size of the resource (by increasing the number of nodes) allocated to the ML model. If the volume of requests, the length of a task queue, or a wait time is below a threshold value, the data management system can decrease the size of the resource (by decreasing the number of nodes) allocated to the ML model.

In various embodiments, historical workload data can be used to predict future workload demand. For example, recurring patterns, such as daily peaks in traffic, can be identified based on historical workload data. The size of the GPU resource can be preemptively adjusted to handle the traffic before a peak occurs.

In various embodiments, the data management system uses the ML model to process the plurality of requests based on the metadata preconfigured for the ML model. As described herein, metadata preconfigured for an ML model can include a GPU allocation policy, a CPU allocation policy, and a memory allocation policy. These allocation policies, collectively referred to as resource allocation policies, are preconfigured based on one or more characteristics of a particular ML model, or the type or category of the ML model. Resource allocation policies can efficiently manage and distribute computing resources for ML models served on the machine learning platform, optimize resource utilization, prioritize tasks based on system or user needs, and ensure fair access to computing resources.

In various embodiments, resource allocation policies can determine if a computing task can be handled by one or more CPU nodes and/or one or more GPU nodes, depending on the volume of requests received at a given time. For example, a video that may take a CPU node one minute to process through an ML model can be handled by a GPU node in just one second. By configuring resource allocation policies for the ML model to prioritize GPU nodes for such tasks, system efficiency can be significantly improved.

In various embodiments, metadata preconfigured for an ML model can also specify the types and volumes of data that the appropriate allocation of GPU or CPU nodes can process. For example, large-scale image datasets may be assigned to multiple GPU nodes for faster processing, while smaller, less complex data can be efficiently handled by a fewer number of CPU nodes.

In another example, processing an image by an ML model can involve a sequence where the image is first preprocessed by one or more CPU nodes, such as resizing or filtering, and then further processed by one or more GPU nodes for more computationally intensive tasks, such as deep learning inference or feature extraction. This combination of CPU and GPU utilization optimizes the overall processing pipeline, leveraging the strengths of each type of resource. Based on the resource allocation policies included in the metadata preconfigured for the ML model, the CPU preprocessing tasks can be assigned to a CPU node located on a physical machine that is different from the GPU node responsible for postprocessing. This approach effectively avoids CPU/memory bottlenecks, allowing for flexible resource allocation and ensuring that the most suitable hardware handles each stage of the processing pipeline.

In various embodiments, various requests received via a user interface or an Application Programmable Interface (API) are processed and output via the same or a different user interface or API.

Reference will now be made in detail to embodiments of the present disclosure, examples of which are illustrated in the appended drawings. The present disclosure may, however, be embodied in many different forms and should not be construed as being limited to the embodiments set forth herein.

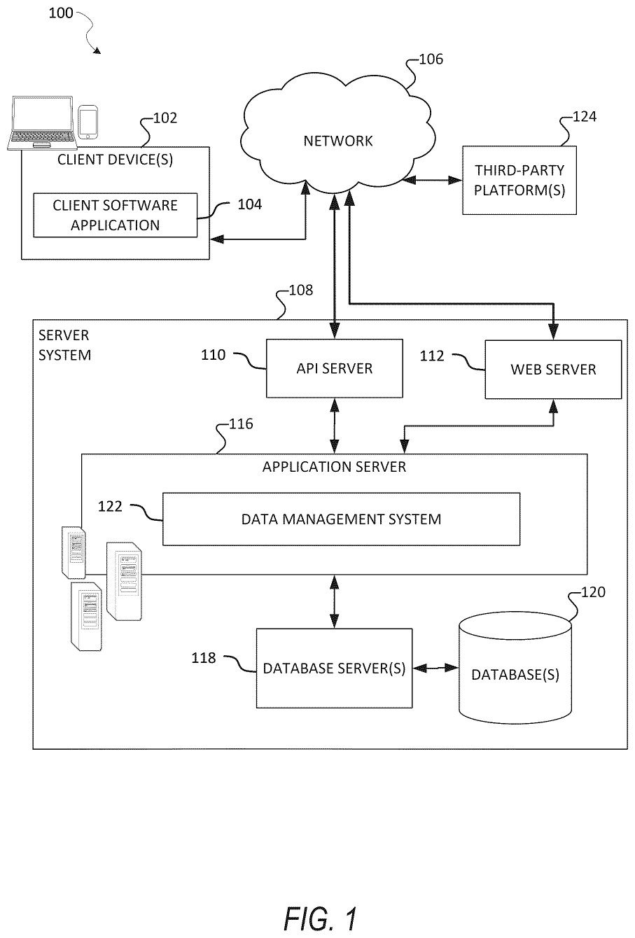

FIG. 1 is a block diagram showing an example data system 100 that includes a data management system 122 (also referred to as system 122), according to various embodiments of the present disclosure. By including the data management system 122, the data system 100 can facilitate enhancing machine learning workloads with optimized GPU utilization. As shown, the data system 100 includes one or more client devices 102, a server system 108, and a network 106 (e.g., Internet, wide-area-network (WAN), local-area-network (LAN), wireless network) that communicatively couples them together. Each client device 102 can host a number of applications, including a client software application 104. The client software application 104 can communicate data with the server system 108 via a network 106. Accordingly, the client software application 104 can communicate and exchange data with the server system 108 via network 106.

The server system 108 provides server-side functionality via the network 106 to the client software application 104. While certain functions of the data system 100 are described herein as being performed by the data management system 122 on the server system 108, it will be appreciated that the location of certain functionality within the server system 108 is a design choice. For example, it may be technically preferable to initially deploy certain technology and functionality within the server system 108, but to later migrate this technology and functionality to the client software application 104.

The server system 108 supports various services and operations that are provided to the client software application 104 by the data management system 122. Such operations include transmitting data from the data management system 122 to the client software application 104, receiving data from the client software application 104 at the data management system 122, and the data management system 122 processing data generated by the client software application 104. Data exchanges within the data system 100 may be invoked and controlled through operations of software component environments available via one or more endpoints, or functions available via one or more user interfaces of the client software application 104, which may include web-based user interfaces provided by the server system 108 for presentation at the client device 102.

With respect to the server system 108, an Application Program Interface (API) server 110 and a web server 112 is coupled to an application server 116, which hosts the data management system 122. The application server 116 is communicatively coupled to a database server 118, which facilitates access to a database 120 that stores data associated with the application server 116, including data that may be generated or used by the data management system 122.

The API server 110 receives and transmits data (e.g., API calls, commands, requests, responses, and authentication data) between the client device 102 and the application server 116. Specifically, the API server 110 provides a set of interfaces (e.g., routines and protocols) that can be called or queried by the client software application 104 in order to invoke the functionality of the application server 116. The API server 110 exposes various functions supported by the application server 116 including, without limitation, user registration; login functionality; data object operations (e.g., generating, storing, retrieving, encrypting, decrypting, transferring, access rights, licensing); and/or user communications.

Through one or more web-based interfaces (e.g., web-based user interfaces), the web server 112 can support various functionality of the data management system 122 of the application server 116.

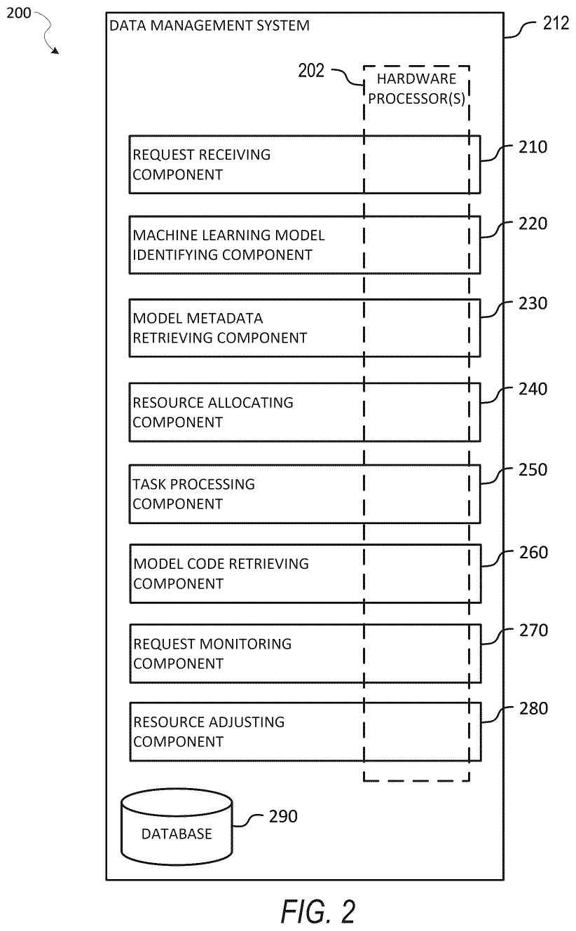

FIG. 2 is a block diagram 200 illustrating an example data management system 212 that facilitates enhancing machine learning workloads with optimized GPU utilization, according to various embodiments of the present disclosure. For some embodiments, the data management system 212 represents an example of the data management system 122 described with respect to FIG. 1. As shown, the data management system 212 comprises a request receiving component 210, a machine learning model identifying component 220, a model metadata retrieving component 230, a resource allocating component 240, a task processing component 250, a model code retrieving component 260, a request monitoring component 270, and a resource adjusting component 280. According to various embodiments, one or more of the request receiving component 210, the machine learning model identifying component 220, the model metadata retrieving component 230, the resource allocating component 240, the task processing component 250, the model code retrieving component 260, the request monitoring component 270, and the resource adjusting component 280 are implemented by one or more hardware processors 202. Data generated by one or more of the request receiving component 210, the machine learning model identifying component 220, the model metadata retrieving component 230, the resource allocating component 240, the task processing component 250, the model code retrieving component 260, the request monitoring component 270, and the resource adjusting component 280 may be stored in a database (or datastore) 290 of the data management system 212.

The request receiving component 210 is configured to receive one or more requests. Each request can be associated with a computing task to be handled (or processed) by a machine learning model. Example computing tasks handled by machine learning models can include, without limitation, image and text classification, object detection, regression, anomaly detection, recommendation systems, time series forecasting, clustering, reinforcement learning, ranking, generative models, and predictive maintenance.

The machine learning model identifying component 220 is configured to identify machine learning (ML) models (or types or categories of ML models) based on one or more requests. For example, the machine learning model identifying component 220 is configured to parse a request to extract relevant information, such as input data, model identifiers, or specific parameters that are indicative of a model being requested.

The model metadata retrieving component 230 is configured to retrieve metadata preconfigured for the ML model (or the type or category of ML models). Example metadata preconfigured for an ML model can include a GPU allocation policy, a CPU allocation policy, and a memory allocation policy preconfigured based on one or more characteristics of the ML model (or the type or category of the ML model).

The resource allocating component 240 is configured to dynamically allocate resources (e.g., GPU nodes, CPU nodes, memory) based on the metadata preconfigured for the ML model. The GPU resource comprises one or more GPU nodes. Each GPU node can correspond to a physical machine (e.g., a computer). Each computer can have one or more CPUs and one or more GPUs. A CPU handles general-purpose computing tasks and manages the system's operations, while a GPU is specialized for parallel processing and accelerates tasks like graphics rendering, machine learning, and complex computations. This combination of CPU and GPU utilization optimizes the overall processing pipeline, leveraging the strengths of each type of resource. Based on the resource allocation policies included in the metadata preconfigured for the ML model, the CPU preprocessing tasks can be assigned to a CPU node located on a physical machine that is different from the GPU node. This approach effectively avoids CPU/memory bottlenecks, allowing for flexible resource allocation and ensuring that the most suitable hardware handles each stage of the processing pipeline.

The task processing component 250 is configured to use allocated resources to process the computing tasks associated with one or more requests.

The model code retrieving component 260 is configured to retrieve GPU code and/or CPU code associated with an identified ML model. The task processing component 250 is configured to use the retrieved code to process the computing tasks. For example, in a machine learning workflow, CPU and GPU work together to optimize performance. CPU can handle coordination tasks, such as preparing data batches and managing the training loop, while GPU can perform computation-heavy operations like matrix calculations and backpropagation. During model serving, the choice (configured via metadata described herein) between using the CPU or GPU depends on the model's characteristics (e.g., size, complexity, model parallelism, data parallelism, batch size, training time) and performance needs. GPUs may be preferred for real-time inference with large models. CPUs can be used for smaller models or resource-constrained environments.

The request monitoring component 270 is configured to monitor the volume of incoming requests executable by an ML model. The volume of requests can be monitored via various metrics. An example metric can involve monitoring the volume of requests based on the length of the task queue and the time tasks spend waiting for a resource (e.g., one or more GPU nodes) allocated to the ML model. Each node (e.g., GPU node, CPU node) allocated to the ML model can be associated with a queue. A longer task queue and/or a longer wait time indicate an increased demand, and vice versa. Another example metric can involve using historical workload data to predict future workload demand. This allows for adjusting resources proactively before a surge in requests occurs, avoiding resource shortages or overprovisioning.

The resource adjusting component 280 is configured to dynamically adjust the size of the resources (e.g., GPU resources, CPU resources) in response to the monitoring of the requests. For example, if the volume of requests, the length of a task queue, and/or a wait time exceeds a threshold value, the resource adjusting component 280 can increase the size of the resource (by increasing the number of nodes) allocated to the ML model. If the volume of requests, the length of a task queue, or a wait time is below a threshold value, the resource adjusting component 280 can decrease the size of the resource (by decreasing the number of nodes) allocated to the ML model accordingly. When historical workload data (e.g., recurring patterns of traffic) is used to predict future workload demand, the resource adjusting component 280 can be configured to preemptively adjust the size of resources to handle the traffic before a recurring pattern occurs.

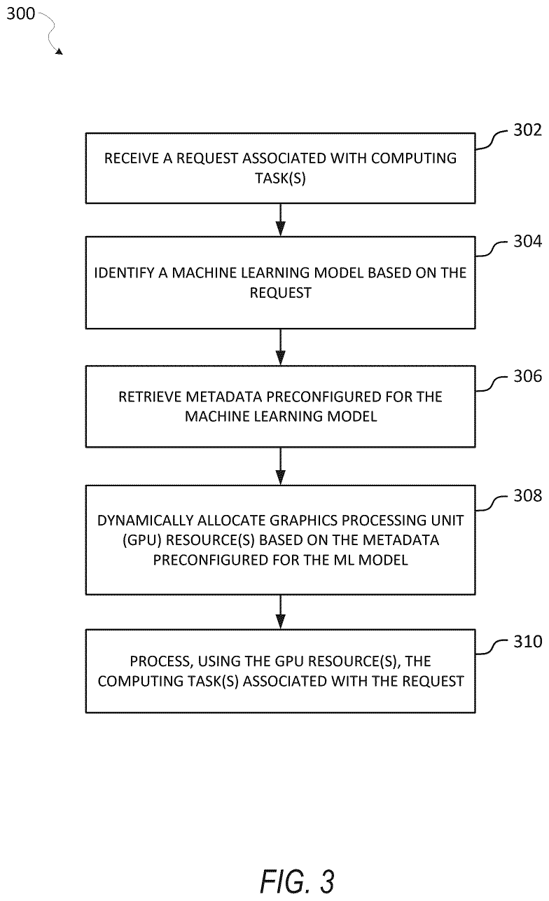

FIG. 3 is a flowchart illustrating an example method 300 for enhancing machine learning workloads with optimized GPU utilization, according to various embodiments of the present disclosure. It will be understood that example methods described herein may be performed by a machine in accordance with some embodiments. For example, method 300 can be performed by the data management system 122 described with respect to FIG. 1, the data management system 212 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 300 may be represented by executable instructions that, when executed by a processor of a computing device, cause the computing device to perform method 300. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel.

At operation 302, a processor receives one or more requests. Each request can be associated with a computing task to be handled (or processed) by a machine learning model. Example computing tasks handled by machine learning models can include, without limitation, image and text classification, object detection, regression, anomaly detection, recommendation systems, time series forecasting, clustering, reinforcement learning, ranking, generative models, and predictive maintenance.

At operation 304, a processor identifies machine learning (ML) models (or types or categories of ML models) based on one or more requests. For example, the processor can parse a request to extract relevant information, such as input data, model identifiers, or specific parameters that are indicative of a model being requested. An example ML model can be a model served on the machine learning platform described herein. A served (or deployed) machine learning model can handle live (or real-time) requests (from users and systems), process data in the live request, and return results (via model outputs) through APIs or user interfaces described herein.

At operation 306, a processor retrieves metadata preconfigured for the ML model (or the type or category of ML models). Example metadata preconfigured for an ML model can include a GPU allocation policy, a CPU allocation policy, and a memory allocation policy preconfigured based on one or more characteristics of the ML model (or the type or category of the ML model). These allocation policies, collectively referred to as resource allocation policies, can determine if a computing task can be handled by one or more CPU nodes and/or one or more GPU nodes, depending on the volume of requests received at a given time. For example, a video that may take a CPU node one minute to process through an ML model can be handled by a GPU node in just one second. By configuring resource allocation policies for the ML model to prioritize GPU nodes for such tasks, system efficiency can be significantly improved.

At operation 308, a processor dynamically allocates resources (e.g., GPU resources, CPU resources, memory resources) based on at least one of the resource allocation policies included in the metadata preconfigured for the ML model. A GPU resource can include one or more GPU nodes. Each GPU node can correspond to a physical machine (e.g., a computer). Each computer can have one or more CPUs and one or more GPUs. Based on the resource allocation policies included in the metadata preconfigured for the ML model, CPU preprocessing tasks can be assigned to a CPU node located on a physical machine that is different from one or more GPU nodes allocated to the model. This approach effectively avoids CPU/memory bottlenecks, allowing for flexible resource allocation and ensuring that the most suitable hardware handles each stage of the processing pipeline.

In various embodiments, the processor can cause a distributed computing framework to dynamically allocate the resources (e.g., GPU nodes, CPU nodes, memory) based on the metadata preconfigured for the ML model. The distributed computing framework is communicatively coupled to the data management system and is designed to scale and simplify the development of machine learning (ML) and other high-performance applications. In particular, the distributed computing framework can distribute tasks across multiple nodes (e.g., GPU nodes) in a cluster. This makes it easier to scale up machine learning workloads that require extensive resources (e.g., GPU resources).

At operation 310, a processor processes computing tasks associated with one or more requests based on the allocated resources.

Though not illustrated, method 300 can include an operation where a graphical user interface is displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 302 through 310 or, alternatively, form part of one or more of operations 302 through 310.

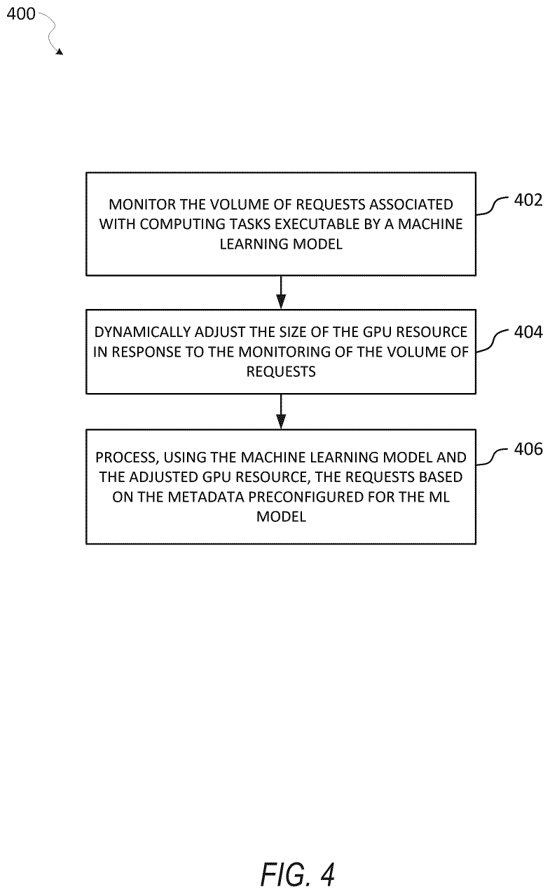

FIG. 4 is a flowchart illustrating an example method 400 for enhancing machine learning workloads with optimized GPU utilization, according to various embodiments of the present disclosure. It will be understood that example methods described herein may be performed by a machine in accordance with some embodiments. For example, method 400 can be performed by the data management system 122 described with respect to FIG. 1, the data management system 212 described with respect to FIG. 2, or individual components thereof. An operation of various methods described herein may be performed by one or more hardware processors (e.g., central processing units or graphics processing units) of a computing device (e.g., a desktop, server, laptop, mobile phone, tablet, etc.), which may be part of a computing system based on a cloud architecture. Example methods described herein may also be implemented in the form of executable instructions stored on a machine-readable medium or in the form of electronic circuitry. For instance, the operations of method 400 may be represented by executable instructions that, when executed by a processor of a computing device, cause the computing device to perform method 400. Depending on the embodiment, an operation of an example method described herein may be repeated in different ways or involve intervening operations not shown. Though the operations of example methods may be depicted and described in a certain order, the order in which the operations are performed may vary among embodiments, including performing certain operations in parallel. Operations in method 400 can be performed dependently or independently from operations in method 300.

At operation 402, a processor monitors the volume of incoming requests executable by an ML model. The volume of requests can be monitored via various metrics. An example metric can involve monitoring the volume of requests based on the length of the task queue and the time tasks spend waiting for a resource (e.g., one or more GPU nodes) allocated to the ML model. Each node (e.g., GPU node, CPU node) allocated to the ML model can be associated with a queue. A longer task queue and/or a longer wait time indicate an increased demand, and vice versa. Another example metric can involve using historical workload data to predict future workload demand. This allows for adjusting resources proactively before a surge in requests occurs, avoiding resource shortages or overprovisioning.

At operation 404, a processor dynamically adjusts the size of the resources (e.g., GPU resources, CPU resources, memory resources) in response to the monitoring of the requests. For example, if the volume of requests, the length of a task queue, and/or a wait time exceeds a threshold value, the processor can increase the size of a GPU resource (by increasing the number of GPU nodes) allocated to the ML model. If the volume of requests, the length of a task queue, or a wait time is below a threshold value, the processor can decrease the size of the GPU resource (by decreasing the number of GPU nodes) allocated to the ML model. When historical workload data (e.g., recurring patterns of traffic) is used to predict future workload demand, the processor can preemptively adjust the size of the GPU resource to handle the traffic before a recurring pattern occurs. In various embodiments, the processor can cause a distributed computing framework to dynamically allocate the resources based on the metadata preconfigured for the ML model, as described herein.

At operation 406, a processor uses a machine learning model and the adjusted resources (e.g., GPU resources, CPU resources, memory resources) to process computing tasks based on the retrieved metadata preconfigured for the ML model.

Though not illustrated, method 400 can include an operation where a graphical user interface can be displayed (or caused to be displayed) by the hardware processor. For instance, the operation can cause a client device (e.g., the client device 102 communicatively coupled to the data management system 122) to display the graphical user interface. This operation for displaying the graphical user interface can be separate from operations 402 through 406 or, alternatively, form part of one or more of operations 402 through 406.

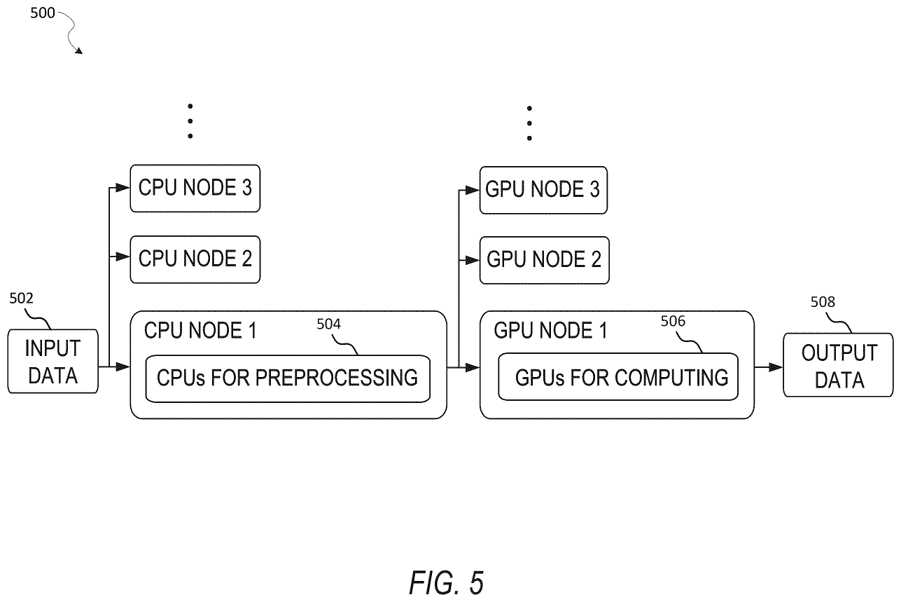

FIG. 5 is a diagram illustrating a data flow 500 that facilitates enhancing machine learning workloads with optimized GPU utilization, according to various embodiments of the present disclosure. As shown, the data flow 500 represents a machine learning workflow described herein. Upon receiving input data 502 via one or more requests, the data management system (e.g., systems 122, 212) can identify a machine learning (ML) model (not shown) based on the request. The input data 502 can include image data, video data, 3D data, and/or audio data, as examples. Upon identifying the ML model, the data management system can retrieve metadata preconfigured for the model. The metadata can include a GPU resource allocation policy, a CPU resource allocation policy, and a memory resource allocation policy. Based on these policies, the data management system can dynamically allocate GPU nodes (e.g., GPU NODES 1, 2, 3), CPU nodes (e.g., CPU NODES 1, 2, 3), and memory (not shown) to the model for processing the input data 502. The number of nodes, by no means limited to three as illustrated, can be dynamically adjusted (e.g., scaled up or down) based on various metrics associated with the model's workload, including metrics involving the volume of incoming requests queued up at each allocated node, historical workload data, response time, etc. For example, if the number of incoming requests for model inference spikes during peak traffic hours (e.g., an e-commerce website during Black Friday sales), additional GPU nodes can be dynamically allocated to handle the increased load, ensuring low-latency responses. In another example, based on historical data showing that model training workloads tend to be heavier on weekends (e.g., periodic model retraining jobs in a financial forecasting system), the data management system can preemptively scale up the number of GPU nodes on Friday evenings to meet the expected demand. In another example, if GPU utilization across existing nodes consistently exceeds 80%, more nodes can be allocated to balance the load, ensuring that the GPUs are not overburdened, and that processing remains efficient. In yet another example, if response times from the model start to exceed critical latency thresholds (e.g., 10 milliseconds), additional nodes are spun up to maintain the performance requirements needed for safe operation.

As shown, the model can generate output data 508. Example output data 508 can include embeddings.

CPU nodes (e.g., CPU NODES 1, 2, 3) may or may not reside on the same physical machine as the GPU nodes (e.g., GPU NODES 1, 2, 3). In some instances, the CPU preprocessing tasks can be assigned to a CPU node located on a physical machine different from the GPU node responsible for postprocessing (or computing). This approach effectively avoids CPU/memory bottlenecks, allowing for flexible resource allocation and ensuring that the most suitable hardware handles each stage of the processing pipeline.

As shown, a single GPU node (e.g., GPU NODE 1) can house multiple GPUs 506. This is common in high-performance computing environments, data centers, and cloud services. Multi-GPU nodes are used to achieve greater computational power and handle more demanding workloads. Similarly, A single CPU node (e.g., CPU NODE 1) can house multiple CPUs 504.

Described implementations of the subject matter can include one or more features, alone or in combination as illustrated below by way of example.

Example 1 is a system comprising: one or more hardware processors; and at least one machine-storage medium for storing instructions that, when executed by the one or more hardware processors, cause the one or more hardware processors to perform operations comprising: receiving a request associated with a computing task; identifying a machine learning (ML) model based on the request; retrieving metadata preconfigured for the ML model; dynamically allocating a graphics processing unit (GPU) resource based on the metadata preconfigured for the ML model; and processing, using the GPU resource, the computing task associated with the request.

In Example 2, the subject matter of Example 1 includes, wherein the GPU resource comprises one or more GPU nodes.

In Example 3, the subject matter of Example 2 includes, wherein each GPU node corresponds to a physical machine.

In Example 4, the subject matter of Examples 2-3 includes, wherein the operations comprise: retrieving GPU code associated with the ML model; and processing, using the one or more GPU nodes, the computing task associated with the request based on the GPU code.

In Example 5, the subject matter of Examples 1-4 includes, wherein the operations comprise: dynamically allocating a central processing unit (CPU) resource and a memory resource based on the request; and processing, using the CPU resource, the memory resource and the GPU resource, the computing task associated with the request.

In Example 6, the subject matter of Examples 1-5 includes, wherein the metadata comprises a GPU allocation policy, a CPU allocation policy, and a memory allocation policy preconfigured based on one or more characteristics of the ML model.

In Example 7, the subject matter of Examples 1-6 includes, wherein the operations comprise: monitoring a volume of a plurality of requests associated with computing tasks executable by the ML model; and dynamically adjusting a size of the GPU resource in response to the monitoring of the volume of the plurality of requests.

In Example 8, the subject matter of Example 7 includes, wherein the operations comprise: processing, using the ML model, the plurality of requests based on the metadata preconfigured for the ML model.

In Example 9, the subject matter of Examples 1-8 includes, wherein the request is received via a user interface or an Application Programmable Interface (API), and wherein a result of the processing of the computing task associated with the request is provided via the user interface or the API.

In Example 10, the subject matter of Examples 1-9 includes, wherein the ML model is deployed on a machine learning platform that provides a plurality of ML models that handle real-time requests associated with computing tasks.

Example 11 is a method comprising: receiving a request associated with a computing task; identifying a machine learning (ML) model based on the request; retrieving metadata preconfigured for the ML model; dynamically allocating a graphics processing unit (GPU) resource based on the metadata preconfigured for the ML model; and processing, using the GPU resource, the computing task associated with the request.

In Example 12, the subject matter of Example 11 includes, wherein the GPU resource comprises one or more GPU nodes.

In Example 13, the subject matter of Example 12 includes, wherein each GPU node corresponds to a physical machine.

In Example 14, the subject matter of Examples 12-13 includes, retrieving GPU code associated with the ML model; and processing, using the one or more GPU nodes, the computing task associated with the request based on the GPU code.

In Example 15, the subject matter of Examples 11-14 includes, dynamically allocating a central processing unit (CPU) resource and a memory resource based on the request; and processing, using the CPU resource, the memory resource and the GPU resource, the computing task associated with the request.

In Example 16, the subject matter of Examples 11-15 includes, wherein the metadata comprises a GPU allocation policy, a CPU allocation policy, and a memory allocation policy preconfigured based on one or more characteristics of the ML model.

In Example 17, the subject matter of Examples 11-16 includes, monitoring a volume of a plurality of requests associated with computing tasks executable by the ML model; and dynamically adjusting a size of the GPU resource in response to the monitoring of the volume of the plurality of requests.

In Example 18, the subject matter of Example 17 includes, processing, using the ML model, the plurality of requests based on the metadata preconfigured for the ML model.

In Example 19, the subject matter of Examples 11-18 includes, wherein the request is received via a user interface or an Application Programmable Interface (API), wherein a result of the processing of the computing task associated with the request is provided via the user interface or the API, and wherein the ML model is deployed on a machine learning platform that provides a plurality of ML models that handle real-time requests associated with computing tasks.

Example 20 is a machine-storage medium for storing instructions that, when executed by one or more hardware processors, cause the one or more hardware processors to perform operations comprising: receiving a request associated with a computing task; identifying a machine learning (ML) model based on the request; retrieving metadata preconfigured for the ML model; dynamically allocating a graphics processing unit (GPU) resource based on the metadata preconfigured for the ML model; and processing, using the GPU resource, the computing task associated with the request.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

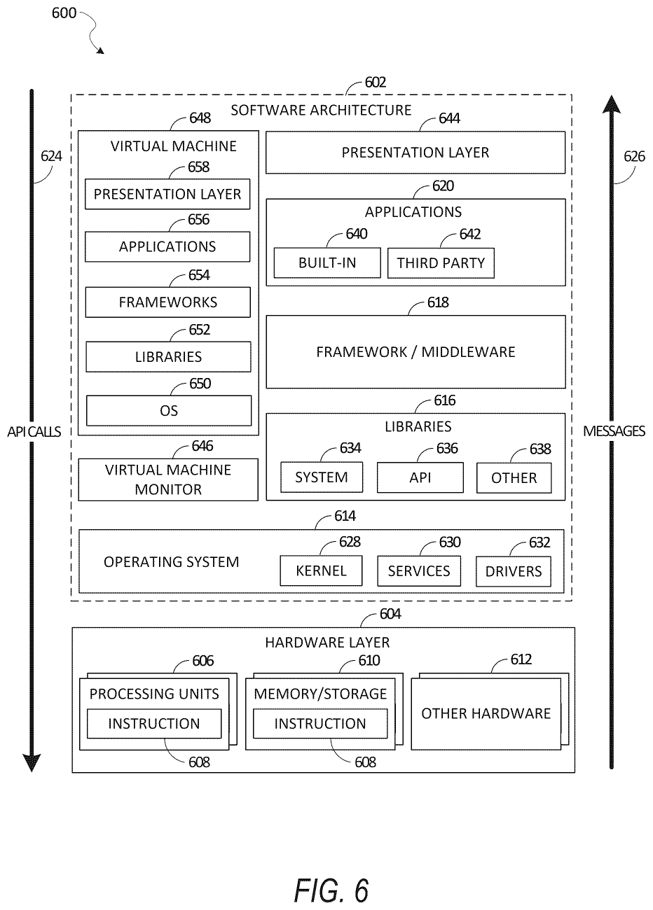

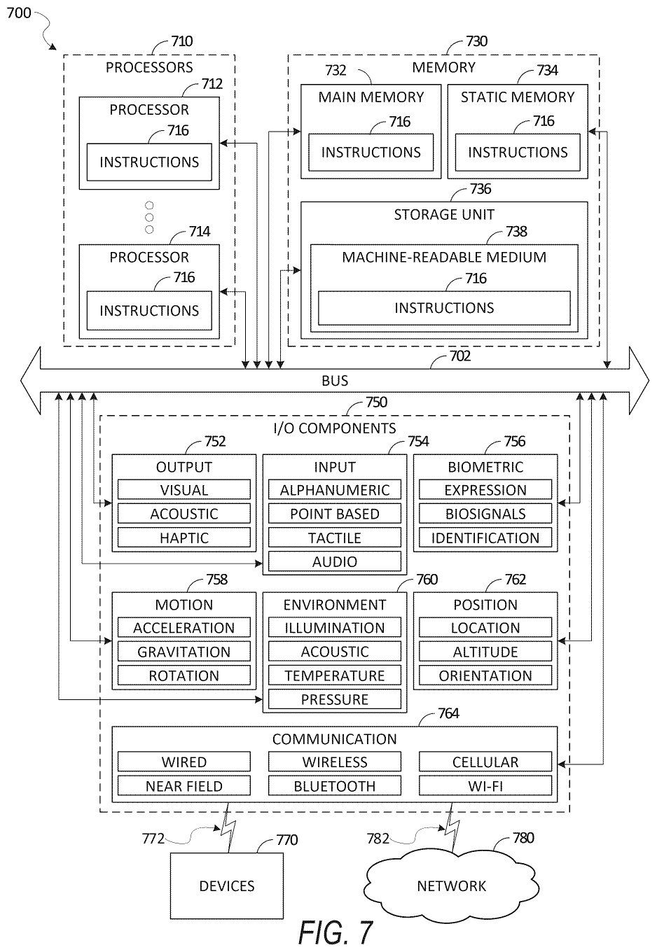

FIG. 6 is a block diagram illustrating an example of a software architecture 602 that may be installed on a machine, according to some example embodiments. FIG. 6 is merely a non-limiting example of a software architecture, and it will be appreciated that many other architectures may be implemented to facilitate the functionality described herein. The software architecture 602 may be executing on hardware such as a machine 700 of FIG. 7 that includes, among other things, processors 710, memory 730, and input/output (I/O) components 750. A representative hardware layer 604 is illustrated and can represent, for example, the machine 700 of FIG. 7. The representative hardware layer 604 comprises one or more processing units 606 having associated executable instructions 608. The executable instructions 608 represent the executable instructions of the software architecture 602. The hardware layer 604 also includes memory or storage modules 610, which also have the executable instructions 608. The hardware layer 604 may also comprise other hardware 612, which represents any other hardware of the hardware layer 604, such as the other hardware illustrated as part of the machine 700.

In the example architecture of FIG. 6, the software architecture 602 may be conceptualized as a stack of layers, where each layer provides particular functionality. For example, the software architecture 602 may include layers such as an operating system 614, libraries 616, frameworks/middleware 618, applications 620, and a presentation layer 644. Operationally, the applications 620 or other components within the layers may invoke API calls 624 through the software stack and receive a response, returned values, and so forth (illustrated as messages 626) in response to the API calls 624. The layers illustrated are representative in nature, and not all software architectures have all layers. For example, some mobile or special-purpose operating systems may not provide a frameworks/middleware 618 layer, while others may provide such a layer. Other software architectures may include additional or different layers.

The operating system 614 may manage hardware resources and provide common services. The operating system 614 may include, for example, a kernel 628, services 630, and drivers 632. The kernel 628 may act as an abstraction layer between the hardware and the other software layers. For example, the kernel 628 may be responsible for memory management, processor management (e.g., scheduling), component management, networking, security settings, and so on. The services 630 may provide other common services for the other software layers. The drivers 632 may be responsible for controlling or interfacing with the underlying hardware. For instance, the drivers 632 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 616 may provide a common infrastructure that may be utilized by the applications 620 and/or other components and/or layers. The libraries 616 typically provide functionality that allows other software modules to perform tasks in an easier fashion than by interfacing directly with the underlying operating system 614 functionality (e.g., kernel 628, services 630, or drivers 632). The libraries 616 may include system libraries 634 (e.g., C standard library) that may provide functions such as memory allocation functions, string manipulation functions, mathematic functions, and the like. In addition, the libraries 616 may include API libraries 636 such as media libraries (e.g., libraries to support presentation and manipulation of various media formats such as MPEG4, H.264, MP3, AAC, AMR, JPG, and PNG), graphics libraries (e.g., an OpenGL framework that may be used to render 2D and 3D graphic content on a display), database libraries (e.g., SQLite that may provide various relational database functions), web libraries (e.g., WebKit that may provide web browsing functionality), and the like. The libraries 616 may also include a wide variety of other libraries 638 to provide many other APIs to the applications 620 and other software components/modules.

The frameworks 618 (also sometimes referred to as middleware) may provide a higher-level common infrastructure that may be utilized by the applications 620 or other software components/modules. For example, the frameworks 618 may provide various graphical user interface functions, high-level resource management, high-level location services, and so forth. The frameworks 618 may provide a broad spectrum of other APIs that may be utilized by the applications 620 and/or other software components/modules, some of which may be specific to a particular operating system or platform.

The applications 620 include built-in applications 640 and/or third-party applications 642. Examples of representative built-in applications 640 may include, but are not limited to, a home application, a contacts application, a browser application, a book reader application, a location application, a media application, a messaging application, or a game application.

The third-party applications 642 may include any of the built-in applications 640, as well as a broad assortment of other applications. In a specific example, the third-party applications 642 (e.g., an application developed using the Android™ or iOS™ software development kit (SDK) by an entity other than the vendor of the particular platform) may be mobile software running on a mobile operating system such as iOS™, Android™, or other mobile operating systems. In this example, the third-party applications 642 may invoke the API calls 624 provided by the mobile operating system such as the operating system 614 to facilitate functionality described herein.

The applications 620 may utilize built-in operating system functions (e.g., kernel 628, services 630, or drivers 632), libraries (e.g., system libraries 634, API libraries 636, and other libraries 638), or frameworks/middleware 618 to create user interfaces to interact with users of the system. Alternatively, or additionally, in some systems, interactions with a user may occur through a presentation layer, such as the presentation layer 644. In these systems, the application/module “logic” can be separated from the aspects of the application/module that interact with the user.

Some software architectures utilize virtual machines. In the example of FIG. 6, this is illustrated by a virtual machine 648. The virtual machine 648 creates a software environment where applications/modules can execute as if they were executing on a hardware machine (e.g., the machine 600 of FIG. 6). The virtual machine 648 is hosted by a host operating system (e.g., the operating system 614) and typically, although not always, has a virtual machine monitor 646, which manages the operation of the virtual machine 648 as well as the interface with the host operating system (e.g., the operating system 614). A software architecture executes within the virtual machine 648, such as an operating system 650, libraries 652, frameworks 654, applications 656, or a presentation layer 658. These layers of software architecture executing within the virtual machine 648 can be the same as corresponding layers previously described or may be different.

FIG. 7 illustrates a diagrammatic representation of a machine 700 in the form of a computer system within which a set of instructions may be executed for causing the machine 700 to perform any one or more of the methodologies discussed herein, according to an embodiment. Specifically, FIG. 7 shows a diagrammatic representation of the machine 700 in the example form of a computer system, within which instructions 716 (e.g., software, a program, an application, an applet, an app, or other executable code) for causing the machine 700 to perform any one or more of the methodologies discussed herein may be executed. For example, the instructions 716 may cause the machine 700 to execute method 300 described above with respect to FIG. 3, and method 400 described above with respect to FIG. 4. The instructions 716 transform the general, non-programmed machine 700 into a particular machine 700 programmed to carry out the described and illustrated functions in the manner described. In alternative embodiments, the machine 700 operates as a standalone device or may be coupled (e.g., networked) to other machines. In a networked deployment, the machine 700 may operate in the capacity of a server machine or a client machine in a server-client network environment, or as a peer machine in a peer-to-peer (or distributed) network environment. The machine 700 may comprise, but not be limited to, a server computer, a client computer, a personal computer (PC), a tablet computer, a laptop computer, a netbook, a personal digital assistant (PDA), an entertainment media system, a cellular telephone, a smart phone, a mobile device, or any machine capable of executing the instructions 716, sequentially or otherwise, that specify actions to be taken by the machine 700. Further, while only a single machine 700 is illustrated, the term “machine” shall also be taken to include a collection of machines 700 that individually or jointly execute the instructions 716 to perform any one or more of the methodologies discussed herein.

The machine 700 may include processors 710, memory 730, and I/O components 750, which may be configured to communicate with each other such as via a bus 702. In an embodiment, the processors 710 (e.g., a hardware processor, such as a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 712 and a processor 714 that may execute the instructions 716. The term “processor” is intended to include multi-core processors that may comprise two or more independent processors (sometimes referred to as “cores”) that may execute instructions contemporaneously. Although FIG. 7 shows multiple processors 710, the machine 700 may include a single processor with a single core, a single processor with multiple cores (e.g., a multi-core processor), multiple processors with a single core, multiple processors with multiples cores, or any combination thereof.

The memory 730 may include a main memory 732, a static memory 734, and a storage unit 736 including machine-readable medium 738, each accessible to the processors 710 such as via the bus 702. The main memory 732, the static memory 734, and the storage unit 736 store the instructions 716 embodying any one or more of the methodologies or functions described herein. The instructions 716 may also reside, completely or partially, within the main memory 732, within the static memory 734, within the storage unit 736, within at least one of the processors 710 (e.g., within the processor's cache memory), or any suitable combination thereof, during execution thereof by the machine 700.

The I/O components 750 may include a wide variety of components to receive input, provide output, produce output, transmit information, exchange information, capture measurements, and so on. The specific I/O components 750 that are included in a particular machine will depend on the type of machine. For example, portable machines such as mobile phones will likely include a touch input device or other such input mechanisms, while a headless server machine will likely not include such a touch input device. It will be appreciated that the I/O components 750 may include many other components that are not shown in FIG. 7. The I/O components 750 are grouped according to functionality merely for simplifying the following discussion, and the grouping is in no way limiting. In some examples, the I/O components 750 may include output components 752 and input components 754. The output components 752 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 754 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further embodiments, the I/O components 750 may include biometric components 756, motion components 758, environmental components 760, or position components 762, among a wide array of other components. The motion components 758 may include acceleration sensor components (e.g., accelerometer), gravitation sensor components, rotation sensor components (e.g., gyroscope), and so forth. The environmental components 760 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 762 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 750 may include communication components 764 operable to couple the machine 700 to a network 780 or devices 770 via a coupling 782 and a coupling 772, respectively. For example, the communication components 764 may include a network interface component or another suitable device to interface with the network 780. In further examples, the communication components 764 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 770 may be another machine or any of a wide variety of peripheral devices (e.g., a peripheral device coupled via a USB).

Moreover, the communication components 764 may detect identifiers or include components operable to detect identifiers. For example, the communication components 764 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 764, such as location via Internet Protocol (IP) geolocation, location via Wi-Fi® signal triangulation, location via detecting an NFC beacon signal that may indicate a particular location, and so forth.

Certain embodiments are described herein as including logic or a number of components, modules, elements, or mechanisms. Such modules can constitute either software modules (e.g., code embodied on a machine-readable medium or in a transmission signal) or hardware modules. A “hardware module” is a tangible unit capable of performing certain operations and can be configured or arranged in a certain physical manner. In various example embodiments, one or more computer systems (e.g., a standalone computer system, a client computer system, or a server computer system) or one or more hardware modules of a computer system (e.g., a processor or a group of processors) are configured by software (e.g., an application or application portion) as a hardware module that operates to perform certain operations as described herein.

In some examples, a hardware module is implemented mechanically, electronically, or any suitable combination thereof. For example, a hardware module can include dedicated circuitry or logic that is permanently configured to perform certain operations. For example, a hardware module can be a special-purpose processor, such as a field-programmable gate array (FPGA) or an ASIC. A hardware module may also include programmable logic or circuitry that is temporarily configured by software to perform certain operations. For example, a hardware module can include software encompassed within a general-purpose processor or other programmable processor. It will be appreciated that the decision to implement a hardware module mechanically, in dedicated and permanently configured circuitry, or in temporarily configured circuitry (e.g., configured by software) can be driven by cost and time considerations.

Accordingly, the phrase “module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where a hardware module comprises a general-purpose processor configured by software to become a special-purpose processor, the general-purpose processor may be configured as respectively different special-purpose processors (e.g., comprising different hardware modules) at different times. Software can accordingly configure a particular processor or processors, for example, to constitute a particular hardware module at one instance of time and to constitute a different hardware module at a different instance of time.

Hardware modules can provide information to, and receive information from, other hardware modules. Accordingly, the described hardware modules can be regarded as being communicatively coupled. Where multiple hardware modules exist contemporaneously, communications can be achieved through signal transmission (e.g., over appropriate circuits and buses) between or among two or more of the hardware modules. In embodiments in which multiple hardware modules are configured or instantiated at different times, communications between or among such hardware modules may be achieved, for example, through the storage and retrieval of information in memory structures to which the multiple hardware modules have access. For example, one hardware module performs an operation and stores the output of that operation in a memory device to which it is communicatively coupled. A further hardware module can then, at a later time, access the memory device to retrieve and process the stored output. Hardware modules can also initiate communications with input or output devices, and can operate on a resource (e.g., a collection of information).

The various operations of example methods described herein can be performed, at least partially, by one or more processors that are temporarily configured (e.g., by software) or permanently configured to perform the relevant operations. Whether temporarily or permanently configured, such processors constitute processor-implemented modules that operate to perform one or more operations or functions described herein. As used herein, “processor-implemented module” refers to a hardware module implemented using one or more processors.

Similarly, the methods described herein can be at least partially processor-implemented, with a particular processor or processors being an example of hardware. For example, at least some of the operations of a method can be performed by one or more processors or processor-implemented modules. Moreover, the one or more processors may also operate to support performance of the relevant operations in a “cloud computing” environment or as a “software as a service” (SaaS). For example, at least some of the operations may be performed by a group of computers (as examples of machines 700 including processors 710), with these operations being accessible via a network (e.g., the Internet) and via one or more appropriate interfaces (e.g., an API). In certain embodiments, for example, a client device may relay or operate in communication with cloud computing systems and may access circuit design information in a cloud environment.

The performance of certain of the operations may be distributed among the processors, not only residing within a single machine 700, but deployed across a number of machines 700. In some example embodiments, the processors 710 or processor-implemented modules are located in a single geographic location (e.g., within a home environment, an office environment, or a server farm). In other example embodiments, the processors or processor-implemented modules are distributed across a number of geographic locations.

The various memories (i.e., 730, 732, 734, and/or the memory of the processor(s) 710) and/or the storage unit 736 may store one or more sets of instructions 716 and data structures (e.g., software) embodying or utilized by any one or more of the methodologies or functions described herein. These instructions (e.g., the instructions 716), when executed by the processor(s) 710, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 716 and/or data. The terms shall accordingly be taken to include, but not be limited to, solid-state memories, and optical and magnetic media, including memory internal or external to processors. Specific examples of machine-storage media, computer-storage media and/or device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In some examples, one or more portions of the network 780 may be an ad hoc network, an intranet, an extranet, a virtual private network (VPN), a LAN, a wireless LAN (WLAN), a WAN, a wireless WAN (WWAN), a metropolitan-area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 780 or a portion of the network 780 may include a wireless or cellular network, and the coupling 782 may be a Code Division Multiple Access (CDMA) connection, a Global System for Mobile communications (GSM) connection, or another type of cellular or wireless coupling. In this example, the coupling 782 may implement any of a variety of types of data transfer technology, such as Single Carrier Radio Transmission Technology (1xRTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data transfer technology.

The instructions may be transmitted or received over the network using a transmission medium via a network interface device (e.g., a network interface component included in the communication components) and utilizing any one of a number of well-known transfer protocols (e.g., hypertext transfer protocol (HTTP)). Similarly, the instructions may be transmitted or received using a transmission medium via the coupling (e.g., a peer-to-peer coupling) to the devices 770. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions for execution by the machine, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals. For instance, an embodiment described herein can be implemented using a non-transitory medium (e.g., a non-transitory computer-readable medium).

Throughout this specification, plural instances may implement resources, components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components.

As used herein, the term “or” may be construed in either an inclusive or exclusive sense. The terms “a” or “an” should be read as meaning “at least one,” “one or more,” or the like. The presence of broadening words and phrases such as “one or more,” “at least,” “but not limited to,” or other like phrases in some instances shall not be read to mean that the narrower case is intended or required in instances where such broadening phrases may be absent. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. The specification and drawings are, accordingly, to be regarded in an illustrative rather than a restrictive sense.

It will be understood that changes and modifications may be made to the disclosed embodiments without departing from the scope of the present disclosure. These and other changes or modifications are intended to be included within the scope of the present disclosure.

What is claimed is:

1. A system comprising:
one or more hardware processors; and
at least one machine-storage medium for storing instructions that, when executed by the one or more hardware processors, cause the system to perform operations comprising:
receiving a request associated with a computing task;
identifying a machine learning (ML) model based on the request;
retrieving metadata preconfigured for the ML model;
dynamically allocating a graphics processing unit (GPU) resource based on the metadata preconfigured for the ML model; and
processing, using the GPU resource, the computing task associated with the request.

2. The system of claim 1, wherein the GPU resource comprises one or more GPU nodes.

3. The system of claim 2, wherein each GPU node comprises a physical machine.

4. The system of claim 2, wherein the operations comprise:
retrieving GPU code associated with the ML model; and
processing, using the one or more GPU nodes, the computing task associated with the request based on the GPU code.

5. The system of claim 1, wherein the operations comprise:
dynamically allocating a central processing unit (CPU) resource and a memory resource based on the request; and
processing, using the CPU resource, the memory resource and the GPU resource, the computing task associated with the request.

6. The system of claim 1, wherein the metadata comprises a GPU allocation policy, a CPU allocation policy, and a memory allocation policy preconfigured based on one or more characteristics of the ML model.

7. The system of claim 1, wherein the operations comprise:
monitoring a volume of a plurality of requests associated with computing tasks executable by the ML model; and
dynamically adjusting a size of the GPU resource in response to the monitoring of the volume of the plurality of requests.

8. The system of claim 7, wherein the operations comprise:
processing, using the ML model, the plurality of requests based on the metadata preconfigured for the ML model.

9. The system of claim 1, wherein the request is received via a user interface or an Application Programmable Interface (API), and wherein a result of the processing of the computing task associated with the request is provided via the user interface or the API.

10. The system of claim 1, wherein the ML model is deployed on a machine learning platform that provides a plurality of ML models that handle real-time requests associated with computing tasks.

11. A method comprising:
receiving a request associated with a computing task;
identifying a machine learning (ML) model based on the request;
retrieving metadata preconfigured for the ML model;
dynamically allocating a graphics processing unit (GPU) resource based on the metadata preconfigured for the ML model; and
processing, using the GPU resource, the computing task associated with the request.

12. The method of claim 11, wherein the GPU resource comprises one or more GPU nodes.

13. The method of claim 12, wherein each GPU node comprises a physical machine.

14. The method of claim 12, comprising:
retrieving GPU code associated with the ML model; and
processing, using the one or more GPU nodes, the computing task associated with the request based on the GPU code.

15. The method of claim 11, comprising:
dynamically allocating a central processing unit (CPU) resource and a memory resource based on the request; and
processing, using the CPU resource, the memory resource and the GPU resource, the computing task associated with the request.

16. The method of claim 11, wherein the metadata comprises a GPU allocation policy, a CPU allocation policy, and a memory allocation policy preconfigured based on one or more characteristics of the ML model.

17. The method of claim 11, comprising:
monitoring a volume of a plurality of requests associated with computing tasks executable by the ML model; and
dynamically adjusting a size of the GPU resource in response to the monitoring of the volume of the plurality of requests.

18. The method of claim 17, comprising:
processing, using the ML model, the plurality of requests based on the metadata preconfigured for the ML model.

19. The method of claim 11, wherein the request is received via a user interface or an Application Programmable Interface (API), wherein a result of the processing of the computing task associated with the request is provided via the user interface or the API, and wherein the ML model is deployed on a machine learning platform that provides a plurality of ML models that handle real-time requests associated with computing tasks.

20. A machine-storage medium for storing instructions that, when executed by one or more hardware processors, cause the one or more hardware processors to perform operations comprising:
receiving a request associated with a computing task;
identifying a machine learning (ML) model based on the request;
retrieving metadata preconfigured for the ML model;
dynamically allocating a graphics processing unit (GPU) resource based on the metadata preconfigured for the ML model; and
processing, using the GPU resource, the computing task associated with the request.
